(19) United States
(12) Patent Application Publication
(10) Pub. No.: US 2023/0162174 A1
(43) Pub. Date: May 25, 2023

(54) SYSTEM AND METHOD OF AUTOMATED KNOW-YOUR-TRANSACTION CHECKING IN DIGITAL ASSET TRANSACTIONS

(71) Applicant: Blockquake IP Holdings, LLC, new york, NY (US)

(72) Inventors: Antonio Brasse, South Richmond Hill, NY (US); Samuel Brasse, Brooklyn, NY (US); Samuel Hyun, Whitestone, NY (US); Randy Shrikishun, Jamaica, NY (US)

(21) Appl. No.: 17/995,178

(22) PCT Filed: Mar. 30, 2021
(86) PCT No.: PCT/US2021/024809

§ 371 Date: Sep. 30, 2022

Related U.S. Application Data
(60) Provisional application No. 63/001,646, filed on Mar. 30, 2020.

(51) Int. Cl. G06Q 20/36; G06Q 20/40; G06Q 20/38

(52) U.S. Cl. CPC G06Q 20/3674; G06Q 20/4016; G06Q 20/389

(57) ABSTRACT

An automated method of checking for legitimacy during a digital asset transaction, including by a customer, initiating a digital asset transaction, receiving a wallet address corresponding to a wallet, checking the wallet address against one or more databases, wherein said one or more databases comprise wallet transaction history and risk category information, determining if the wallet address should be flagged as a suspicious transaction based on the transaction history and risk category information stored in the one or more databases, if the wallet address is flagged as suspicious, rejecting the transaction and notifying the customer of the rejection. or moving the digital assets to a holding wallet for further checks, and if the wallet address is not flagged as suspicious, releasing the digital assets and proceeding with the transaction.

### CROSS REFERENCE TO RELATED TO APPLICATIONS

This application claims the benefit of U.S. Provisional Patent Application No. 63/001,646 filed Mar. 30, 2020, which is incorporated by reference herein in its entirety.

### FIELD OF THE INVENTION

The present invention is in the field of digital asset transactions. More particularly, the present invention provides a system and method of performing checks and auditing of digital transactions to determine integrity of counterparties and ensure compliance with money laundering and other regulations.

### BACKGROUND OF THE INVENTION

Entities engaging in digital asset transactions currently do not implement preventive automated real-time methods or processes for determining whether certain such transactions are intended to launder money or commit other illegal activities through, the use of digital assets. Such entities are not performing Know-Your-Transaction (KYT) audits or checks, whether preventive or detective, on deposits, transfers, and/or withdrawals in an automated manner. Know-Your-Transaction is a process employed by virtual asset service providers, companies that facilitate virtual asset transactions, and companies that custody virtual assets, to monitor an individual's or business's transaction activity to identify suspicious or fraudulent transactions. Successful KYT analysis would detect high risk activities ranging from Office of Foreign Assets Control (OFAC) sanctioned transactions, scams, and darknet markets. Failure to perform these checks or audits may put these individuals or entities at risk with respect to compliance with Financial Action Task Force (FATF) guidance, Bank Secrecy Act (BSA) requirements, or other anti-money laundering related rules applicable to transfers of tends and digital assets. What is needed is a system and method for performing automated preventive KYT checks in real time upon initiation of digital asset transactions, as disclosed by the present invention. The use of the invention may support compliance with anti-money laundering laws.

### BRIEF DESCRIPTION OF THE DRAWINGS

The drawings, described below, are for illustrative purposes only and are not necessarily drawn to scale. The drawings are not intended to limit the scope of the disclosure in any way. Wherever possible, the same or like reference numbers are used throughout the drawings to refer to the same or like parts.

FIG. 1 is a flowchart illustrating an exemplary method for whitelisting one or more wallet addresses according to the embodiments described herein;

FIG. 2 is a flowchart illustrating an exemplary method for the deposit of digital assets according to the embodiments described herein;

FIG. 3 is a flowchart illustrating an exemplary method for the withdrawal of digital assets according to the embodiments described herein; and

FIG. 4 is a block diagram showing an exemplary system for the implementation of automated real-time KYT checks during digital asset transactions according to the embodiments described herein.

### DETAILED DESCRIPTION OF THE INVENTION

The present invention discloses a system and method of automated preventive KYT checks in real time upon initiation of digital asset transactions. Such digital asset transactions may be recorded on a blockchain (on-chain) or outside of a specific blockchain (off-chain). A blockchain is a digital ledger of transactions which are duplicated and distributed across all computer systems on a peer-to-peer network.

Digital assets may include cryptocurrencies such as bitcoin, Ethereum, and other blockchain-based assets. These cryptocurrencies may also be referred to as tokens, coins, security tokens, or tokenized securities for the tokenization of real estate or other assets. Such tokenized assets may be referred to herein as tradeable or transferable digital assets,

The present invention is ideal for entities engaging in such digital asset transactions. Such entities may, for example, be a natural person, a group of persons, a corporation, a trust, a partnership, or a limited liability company, These entities can include cryptocurrency exchanges, digital asset exchanges, banks, custodians, trusts, or trading desks, or any other entity that engages in or facilitates digital asset transactions. For the purpose of this disclosure only, these entities will hereinafter be referred to each individually as a transaction entity and collectively as transaction entities.

Digital asset transactions may include trades, transfers, deposits, and withdrawals between digital asset wallets (also referred to as digital wallets or wallets) and wallet addresses. A wallet address is a hashed version of a blockchain public key to which transactions can be sent. A public key is publicly known cryptographic code used as a form of identification to allow users to receive cryptocurrencies. A single wallet may have multiple wallet addresses. This is for security reasons to ensure that the wallet is secure from third party access. A wallet is a consolidation of private keys that will correspond to a wallet address. A private key is cryptographic code which is kept secret and used for the authentication, encryption, and access of assets. A private key is used by a wallet owner in order to access and send digital assets from wallet addresses. A passphrase or a seed phrase is a hashed version of a private key. A wallet may either be a cold wallet, a hot wallet, or a warm wallet. Hot wallets are wallets directly connected to the internet, while cold wallets are devices that are specifically designated for physical cryptocurrency storage; offline and disconnected from the internet. In between both hot and cold wallets are warm wallets which share similar characteristics to hot wallets, but warm wallets tend to be based on downloadable software or mobile application instead of a web-based services such as a trading platform or exchange, which utilizes hot wallets. In addition, most warm wallets rely on a passcode or personal identification number (PIN) tor security and identification, whereas hot wallets normally rely on user created passwords as well as having the user verify personal information. By way of example only, a hot wallet may be an online a warm wallet may be a desktop or mobile wallet, and a cold wallet may be a hardware or paper wallet.

KYT checks may resemble anti-money laundering (AML) checks that are performed by traditional financial entities. Such AML checks may be performed against fiat currencies to determine if such funds have been used or may be used in transactions involving illegal activity. KYT checks may serve similar purposes as AML checks but are performed on digital asset transactions taking place within at least one blockchain.

The present invention includes one or more databases which are repositories containing information about digital wallets or digital wallet addresses. The information contained in the one or more databases may include the wallets' transaction histories and risk categories. Such information may be used to determine whether a digital wallet or digital wallet address is being used in financial crimes or other activities that may be considered money laundering. These repositories may be maintained in various forms, including paper format, electronic mail, spreadsheets that use CSV format or Microsoft Excel, or databases, for example, Microsoft Access, Microsoft SQL, or Oracle.

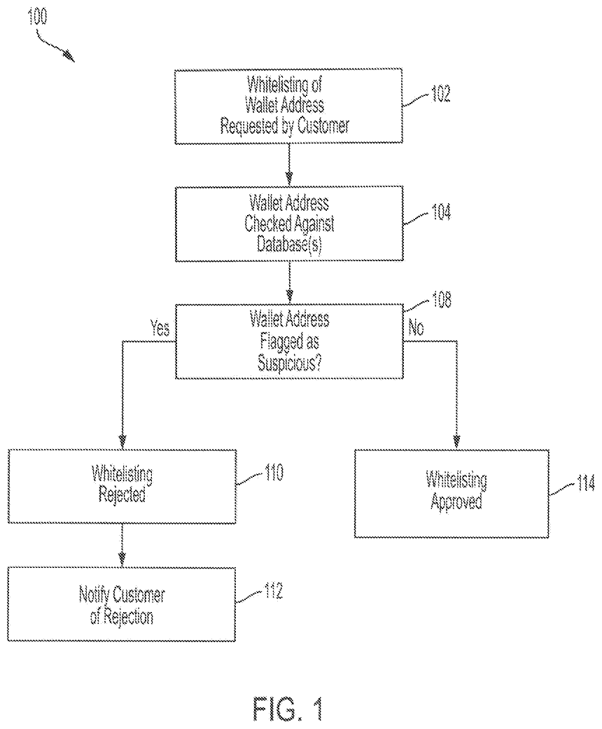

Turning now to the figures, FIG. 1 is a flowchart illustrating an exemplary method for whitelisting one or more wallet addresses according to the embodiments described herein. Whitelisting is the practice of explicitly allowing certain identified entities access to a particular privilege, service, mobility, access, or recognition. When a digital asset wallet address is requested, to be whitelisted 102 to allow for future withdrawal or deposit requests with a transaction entity, the address is checked against one or more databases 104. Such databases may include government databases and databases maintained by reputable and trusted private entities, to determine whether the wallet address is deemed high risk. Such high-risk wallet addresses mays it OFAC blacklisted wallet addresses. Checks are performed in real time and are performed via application programming interface (API) calls between a transaction entity's system and one or more databases. In a preferred embodiment of the present invention, the checks are performed in real time via API calls between a transaction entity's system and a blockchain analysis platform compiling the information from various government and private databases into one platform.

Where it is deemed that the wallet address to be whitelisted is high risk 108 as pre-defined by the transaction entity, the digital asset wallet address whitelisting request is denied 110. The customer of the transaction entity is notified that whitelisting was denied with a detailed explanation 112. The customer may then decide to proceed with attempting to whitelist another wallet address. If the wallet address for the whitelisting request is not flagged as high risk, the whitelisting request for the wallet address is approved 114. In some embodiments of the present invention, the system does not whitelist wallet addresses but instead, conducts checks during each transaction regardless of the result of previous checks,

Databases may be periodically updated by the providers of those databases. A customer of a transaction entity may only withdraw from or deposit to wallet addresses that have been whitelisted and not flagged against the subject databases. Both the external sending or receiving addresses must be whitelisted and go through the same checks as the requesting withdrawal or deposit wallet addresses.

A purpose for whitelisting withdrawal or deposit wallet addresses and requiring non-SMS two factor authentication (2FA) for whitelisting requests, withdrawals, and deposits is to protect a customer's digital assets from theft. Such whitelisting is also directed to proactively identifying potential risky transactions and their underlying behavior to detect fraud, corruption, and money laundering.

The present invention is ideal for transaction entities that may need to implement processes to ensure compliance with FATF guidance and BSA requirements for the handling of virtual currency or digital asset transactions. Such processes may be desirable for the transaction entity where wallet addresses for deposits or withdrawals are required to be whitelisted and where a collection of ether information to meet compliance requirements is desirable. Such other information may include the owner of the wallet address and location of the owner. The information may also include notations as to whether the wallet address belongs to an entity labeled as a virtual asset service provider (VASP). Such notations may benefit customers of a transaction entity receiving or sending digital assets.

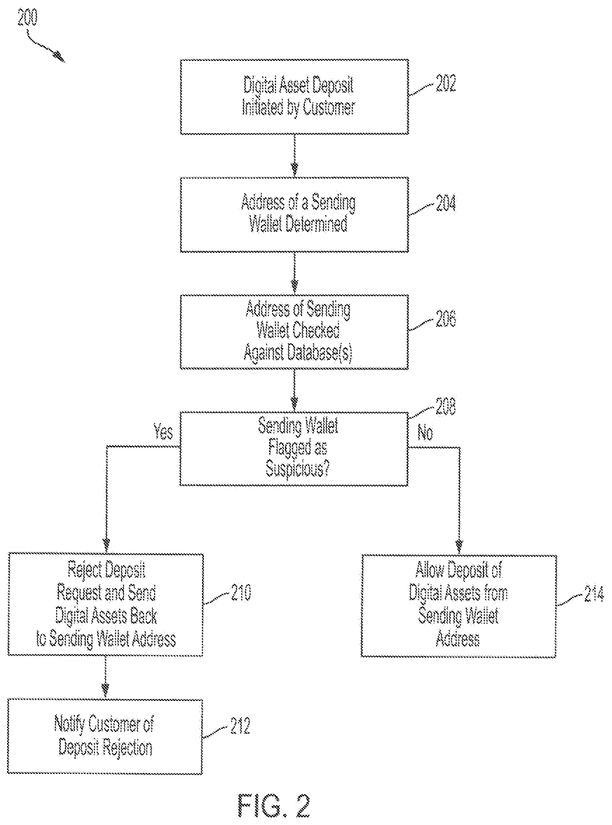

FIG. 2 is a flowchart illustrating an exemplary method for the deposit of digital assets from one wallet to another. When the deposit of a digital asset is initiated by a customer 202, the wallet address of the sending wallet is determined 204 and that transaction or the sending wallet address is checked against one or more databases 206, which may include government-related databases and databases maintained by reputable and trusted private entities. Such checking may determine whether the sending wallet address is deemed high risk. Such high-risk wallet addresses may include OFAC blacklisted wallet addresses. Checks are performed in real time and are performed via API calls. In an embodiment of the present invention, the digital assets are held temporarily in a holding wallet maintained by the transaction entity and separate from the sending wallet, while the wallet address of the sending wallet is checked against the one or more databases.

Where it is determined that the sending wallet address is high risk as pre-defined by the transaction entity 208, digital asset deposits are automatically rejected and returned to the sending wallet address 210. The customer of the transaction entity is notified that there was a deposit that was rejected as a result of it being flagged as high risk 212. In some embodiments of the present invention, if it is determined that the sending wallet address is high risk, the digital assets remain in the holding wallet while further cheeks are being conducted. If the sending wallet address is not flagged as high risk, the deposit proceeds and is credited to the customer's account 214.

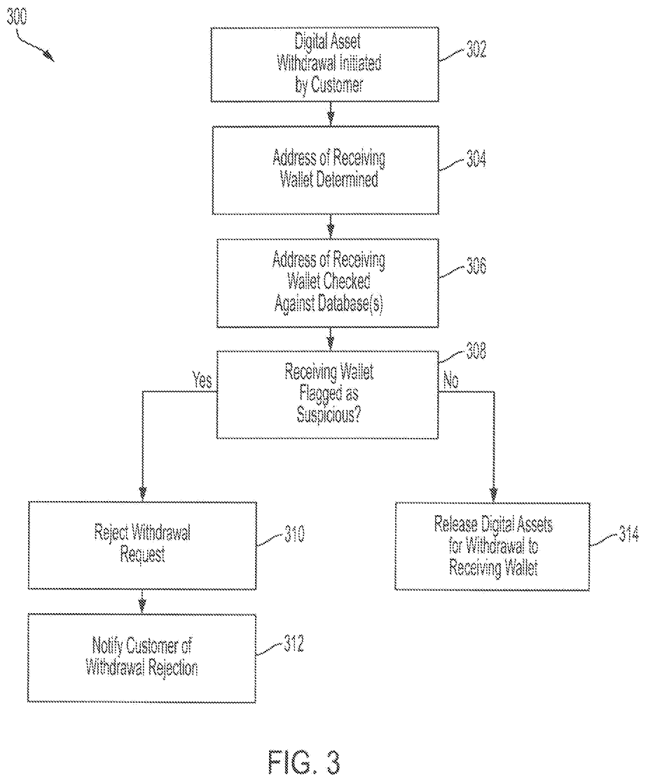

FIG. 3 is a flowchart illustrating exemplary method for the withdrawal of digital assets. When the withdrawal of a digital asset from a transaction entity is initiated by a customer 302, the address of the receiving wallet is determined 304 and that transaction or the receiving wallet address designated for the withdrawal request is checked against one or more databases 306, which may include government and private databases. The checks may determine that the receiving wallet address is deemed high risk. Such high-risk wallet addresses may include OFAC blacklisted wallet addresses. Checks are performed in real time and are performed via API calls. In an embodiment of the present invention, the digital assets are either held temporarily in a holding wallet or remain in the transaction entity's ecosystem separate from the receiving wallet while the wallet address of the receiving wallet is checked against one or more databases.

Where it is determined that the receiving wallet address is high risk as pre-defined by the transaction entity 308, the digital asset withdrawal request is denied 310. The customer of the transaction entity is notified that that the withdrawal request was denied with a detailed explanation 312. The customer is then able to decide whether they want to proceed with a withdrawal request to another wallet address. If the receiving wallet address for the new withdrawal request is not flagged as high risk, the withdrawal proceeds 314.

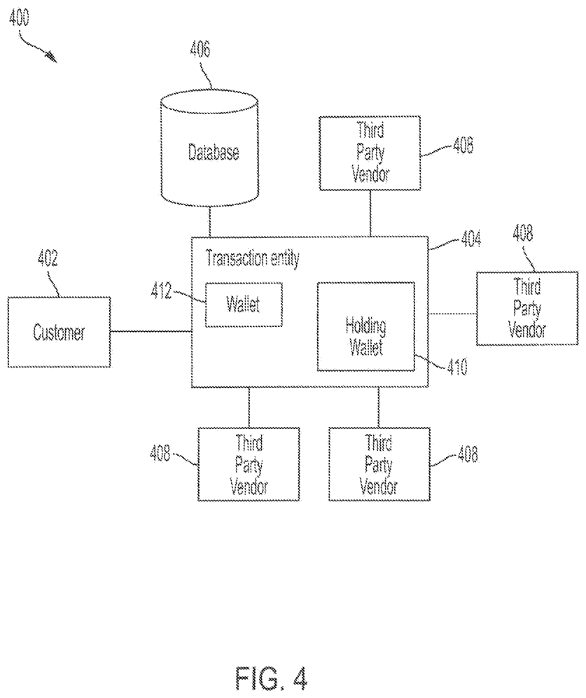

FIG. 4 is a block diagram of a system 400 for the implementation of preventive KYT checks upon initiation of digital asset transactions according to the embodiments disclosed herein. The system 400 may include a customer device 402 through which the customer initiates a digital asset transaction. The customer device may be a laptop, desktop, mobile or other computing device known in the art. The system 400 also includes a transaction entity's software system 404, one or more databases 406, and a plurality of third-party vendor platforms 408.

The transaction entity's software system 404 may he configured as any processing platform known to one of ordinary skill in the art. The transaction entity's software system 404 is configured for the implementation of the digital asset transactions disclosed herein. As part of this implementation, the transaction entity's software system 404 supports a plurality of wallets 412 with corresponding addresses, these wallet addresses serving as a source or destination for the digital asset transactions. The transaction entity's software system 404 also includes a plurality of holding wallets 410 with corresponding holding wallet addresses, these holding wallet addresses serving as a temporary source or destination for the digital assist transactions.

The present invention described herein may be implemented through the use of and communication between a plurality of third-party vendor systems 408 that handle independent processes that are customized and combined to create the present system and method. This may include vendors that provide hot, warm, or cold wallet solutions, wallet address whitelisting capabilities for withdrawal requests, or those that may have some of these aforementioned processes combined. Presently in the art there are existing vendors or entities, government or private, that provide data tracking of wallet addresses for various blockchains for compliance needs, to fight against money laundering and other criminal activity. Currently, this is performed mostly through a manual review process to determine whether any wallet addresses need to be blacklisted. In the present invention, these individual and manual processes are being automated, improved for reliability and efficiency, and combined in such a way to create a new process that allows for automated preventive checks of wallet addresses in real-time to prevent transactions to and from wallet addresses that are deemed high risk.

What is claimed is:

1. An automated method of checking for legitimacy during a digital asset transaction, the automated method comprising the steps of:
by a customer, initiating a digital asset transaction;
receiving a wallet address corresponding to a wallet;
checking the wallet address against one or more databases, wherein said one or more databases comprise wallet transaction history and risk category information;
determining it the wallet address should be flagged as a suspicious transaction based on the transaction history and risk category information stored in the one or more databases;
if the wallet address is flagged as suspicious, rejecting the transaction and notifying the customer of the rejection; and
if the wallet address is not flagged as suspicious, releasing the digital assets.

2. The method of claim 1, further comprising the step if the wallet address is not flagged as suspicious whitelisting the wallet address for future transactions.

3. The method of claim 1, wherein the digital asset transaction comprises the withdrawal of digital assets and the wallet address corresponds to a receiving wallet for receipt of digital assets.

4. The method of claim 1, wherein the digital asset transaction comprises the deposit of digital assets and the wallet address corresponds to a sending wallet for withdrawal of digital assets.

5. An automated method of checking for legitimacy during a digital asset transaction, the automated method comprising the steps of:
by a customer, initiating a digital asset transaction, wherein the digital asset transaction comprises the deposit of digital assets;
receiving a wallet address corresponding to a sending wallet for the withdrawal of digital assets;
moving, temporarily, the digital assets from the sending wallet to a holding wallet;
checking the wallet address against one or more databases, wherein said one or more databases comprise wallet transaction history and risk category information;
determining if the wallet address should be flagged as a suspicious transaction based on the transaction history and risk category information stored in the one or more databases;
if the wallet address is flagged as suspicious, holding the digital assets in the holding wallet for further checks; and
if the wallet address is not flagged as suspicious, releasing the digital assets.

6. The method of claim 5. further comprising, the step if the wallet address is not flagged as suspicious whitelisting the wallet address for future transactions.

7. An automated method of checking for legitimacy during a digital asset transaction, the automated method comprising the steps of:
by a customer, initiating a digital asset transaction, wherein the digital asset transaction comprises the withdrawal of digital assets;
receiving a wallet address corresponding to a receiving wallet for the receipt of digital assets;
moving, temporarily, the digital assets from a sending wallet to a holding wallet;
checking the wallet address against one or more databases, wherein said one or more databases comprise wallet transaction history and risk category information;
determining if the wallet address should be flagged as a suspicious transaction based on the transaction history and risk category information stored in the one or more databases;
if the, wallet address is flagged as suspicious, holding the digital assets in the holding wallet for further checks; and
if the wallet address is not flagged as suspicious, releasing the digital assets.

8. The method of claim 7, further comprising the step if the wallet address is not flagged as suspicious whitelisting the wallet address for future transactions.

9. A system for checking for legitimacy during a digital asset transaction, the system comprising:
a transaction entity software system configured to host a plurality of digital wallets each comprising wallet addresses;
one or more databases comprising wallet transaction history and risk category information, wherein the transaction entity software system is configured to perform checks of the wallet addresses against the one or more databases; and
a means whitelisting or blacklisting a wallet address, said means comprising pre-defined standards which the wallet address must meet during the checks.
